(19) United States
(12) Patent Application Publication
(10) Pub. No.: US 2006/0122837 A1
(43) Pub. Date: Jun. 8, 2006

(54) Voice interface system and speech recognition method

(75) Inventors: Sang Hum Kim, Daejeon (KR); Young Jik Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/297,821

(22) Filed: Dec. 7, 2005

(30) Foreign Application Priority Data
Dec. 8, 2004 (KR) 2004-102918
Jul. 28, 2005 (KR) 2005-69038

(51) Int. Cl. G10L 21/00

(52) U.S. Cl. 704/270.1; 704/228

(57) ABSTRACT

Disclosed are a voice interface system and a speech recognition method, which can be employed in applications such as intelligent robots, can provide natural voice communication, and can improve speech recognition performance. A voice interface server of the voice interface system includes a speech recognition module for performing speech recognition using voice data and detecting a speech recognition error; and an H/O error handling module for obtaining a speech recognition result from a human operator when the speech recognition module detects a speech recognition error.

### CROSS-REFERENCE TO RELATED APPLICATION

This application claims priority to and the benefit of Korean Patent Application Nos. 2004-102918, filed on Dec. 8, 2004, and 2005-69038, filed on Jul. 28, 2005, the disclosure of which is incorporated herein by reference in its entirety.

### BACKGROUND

1. Field of the Invention

The present invention relates to a voice interface system and a speech recognition method, and more particularly, to a voice interface system and a speech recognition method, which can be employed in applications such as intelligent robots, can provide natural voice communication, and can improve speech recognition performance.

2. Discussion of Related Art

Speech recognition is a very convenient function enabling a user to control home electronics and terminal devices and access information vocally. The speech recognition is increasingly employed in advanced applications such as intelligent robots, telematics, and home networks. Especially, in the case of intelligent robots, it is difficult to use an interface such as a keyboard or a mouse. While the speech recognition, video recognition (gesture or character recognition), and sensors (ultrasonic or infrared) are all known to be efficient interface methods for such advanced applications, the speech recognition is considered to possess a particularly high potential for user convenience.

However, a conventional voice interface of a robot usually employs a stand-alone recognition/synthesis engine mounted in the robot that is capable of recognizing no more than 100 simple voice commands to perform desired functions. Further, due to limited resources such as central processing unit (CPU), a memory or the like, it is difficult to realize a conversation-capable voice interface. Also, the commands are typically related to just driving the robot and menu selection, and thus services that can be provided by the robot are limited. Further, the conventional voice interface, due to its inability to handle recognition errors and human errors, is quite user-unfriendly.

### SUMMARY OF THE INVENTION

The present invention is directed to a voice interface system and a speech recognition method, which enable conversation between a robot and a human so that the robot can be used in daily life, developed by considering the handling of recognition errors and human errors, real-time functionality, and user-friendliness, as well as speech recognition.

A first aspect of the present invention provides a voice interface server, including: a speech recognition module for performing speech recognition using voice data and detecting a speech recognition error; and an H/O error handling module for obtaining a speech recognition result from a human operator when the speech recognition module detects a speech recognition error.

A second aspect of the present invention provides a voice interface system, including: a voice interface client for converting a user's voice into voice data and transmitting the voice data to a voice interface server through a communication network; and the voice interface server for performing speech recognition using the voice data transmitted from the voice interface client and obtaining a speech recognition result from a human operator when a speech recognition error is detected.

A third aspect of the present invention provides a voice interface server, including: a speech recognition module for performing speech recognition using voice data; a conversation modeling module for producing a system response in the form of a question for correcting an error when there is an error or a meaning-related error in a speech recognition result produced by the speech recognition module; and a voice synthesis module for converting the question into voice data.

A fourth aspect of the present invention provides a voice interface system, including: a voice interface client for converting a user's voice into voice data and transmitting the voice data to a voice interface server through a communication network; and the voice interface server for performing speech recognition using the voice data transmitted from the voice interface client and producing a system response in the form of a question for correcting an error when there is an error or a meaning-related error in a speech recognition result.

A fifth aspect of the present invention provides a speech recognition method, including the steps of: (a) performing speech recognition using voice data and detecting a speech recognition error; and (b) obtaining a speech recognition result from a human operator when an error is detected in step (a).

A sixth aspect of the present invention provides a speech recognition method, including: (a) performing speech recognition using voice data; (b) producing a system response in the form of a question for correcting an error when there is an error or a meaning-related error in a speech recognition result obtained in step (a); and (c) converting the system response into voice data.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of a voice interface system according to an exemplary embodiment of the present invention.

FIG. 2 is a block diagram illustrating a signal processing flow of the voice interface system of FIG. 1.

FIG. 3 illustrates an information processing procedure when speech recognition is correctly performed and when there is a speech recognition error.

FIG. 4 is a flowchart illustrating a voice interface method which can be performed in the voice interface system of FIG. 1.

FIG. 5 is a flowchart illustrating an example of an H/O error handling process in the voice interface method of FIG. 4.

FIG. 6 is a flowchart illustrating a conversation modeling process in the voice interface method of FIG. 4.

### DETAILED DESCRIPTION OF EXEMPLARY EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art. In the following description, same drawing reference numerals are used for the same elements even in different drawings, and explanations of the same elements are omitted.

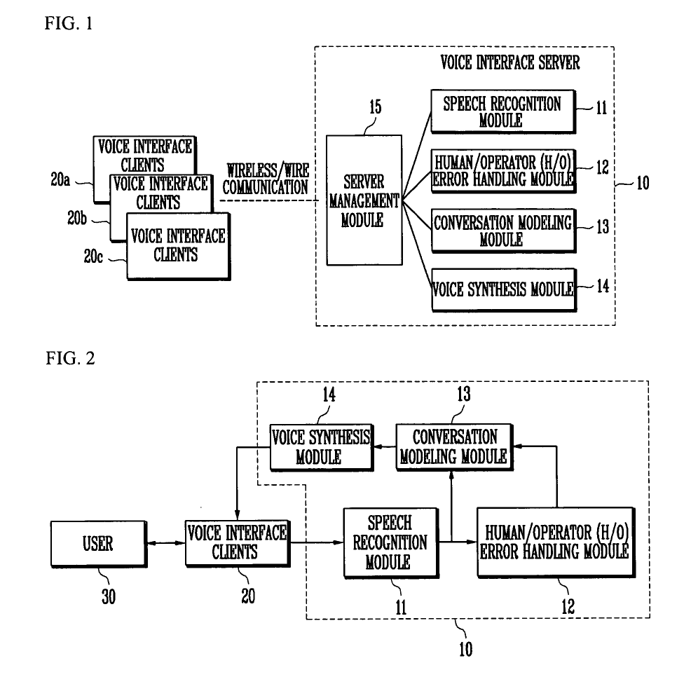

FIG. 1 is a block diagram of a voice interface system according to an exemplary embodiment of the present invention.

Referring to FIG. 1, the voice interface system includes a voice interface server 10 and voice interface clients 20a, 20b and 20c.

The voice interface clients 20a to 20c convert a user's voice into voice data and transfer the voice data to the voice interface server 10. The voice interface clients 20a to 20c can be intelligent robots that communicate with the voice interface server 10 via a wireless communication system such as a wireless LAN or a wire communication system. The voice interface clients 20a to 20c can have an end point detecting function for recognizing start and end points of voice sections. In this case, the voice interface clients 20a to 20c discriminate between a silence section and a voice section and transfer the voice data corresponding to the voice section to the voice interface server 10.

The voice interface server 10 performs speech recognition using the voice data transmitted from the voice interface clients 20a to 20c. The voice interface server 10 includes a speech recognition module 11, and can additionally include a human/operator (H/O) error handling module 12, a conversation modeling module 13, and a voice synthesis module 14. The voice interface server 10 can further include a server management module 15. The respective modules which make up the voice interface server 10 can be implemented in the form of separate servers or hardware. The respective modules which make up the voice interface server 10 can be implemented by separate programs performed in one server or hardware.

The speech recognition module 11 performs the speech recognition using the voice data transmitted from the voice interface clients 20a to 20c. When the voice interface server 10 includes the H/O error handling module 12, the speech recognition module 11 determines whether there is an error in a speech recognition result or not. If there is an error, the H/O error handling module 12 is notified of the error.

The H/O error handling module 12 obtains the speech recognition result from a human operator when the speech recognition module 11 determines that there is an error. In more detail, if the speech recognition module 11 determines that there is an error, the error is corrected by a human operator who hears the voice and directly inputs the accurate speech recognition result. The H/O error handling module 12 has a function for counting and displaying a number of speech recognition errors for each user to assist in correcting an error of a user who is rejected many times, thereby enhancing user-friendliness. The H/O error handling module 12 displays words which often have an error in speech recognition for the human operator to easily select the correct recognition result, resulting in efficient error correction. The H/O error handling module 12 displays words determined to be close to a word having an error so that the human operator can easily select the correct recognition result from among the displayed words, resulting in efficient error correction. The H/O error handling module 12 displays a conversation history so that the human operator can select the correct recognition result more accurately and efficiently. The H/O error handling module 12 has an automatic word indexing function for listing corresponding words when only phonemes are typed, so that the human operator can easily select the correct word without typing the entire word, resulting in efficient error correction. The H/O error handling module 12 has a conversation speed varying function to record the correct speech recognition result after listening to the voice at increased speed, thereby improving H/O error handling speed.

The conversation modeling module 13 performs a system response to correction of an error when there is a meaning-related error in an obtained speech recognition result. For example, assuming that “[date]+[weather]” does not have a meaning-related error, if only “weather” is obtained as the speech recognition result, it is determined as having a meaning-related error in speech recognition which is corrected by asking the user the specific date for which he is curious about the weather. Also, if “father+weather” is obtained as the speech recognition result, it is also determined as having a meaning-related error in speech recognition which is corrected by asking the user the specific date for which he is curious about the weather. By providing such a system response for correcting meaning-related errors, the conversation modeling module 13 enhances the fluidity of communication via the voice interface.

The voice synthesis module 14 converts the system response output from the conversation modeling module 13 into the voice data and transfers it to the voice interface clients 20a to 20c.

The server management module 15 can be used when the speech recognition module 11, the H/O error handling module 12, the conversation modeling module 13, and the voice synthesis module 14 are respectively implemented in the form of independent servers, and can perform real-time processing through load sharing.

If the voice interface clients 20a to 20c are household robots, there may be several voice interface clients 20a to 20c in each household. Each household can request information from the voice interface server 10 through a communication means such as a wireless LAN, and the voice interface server 10 provides an information-processed result according to the voice data transmitted from the voice interface clients 20a to 20c. Such a system enables the voice interface clients 20a to 20c to be purchased at a low price, and also for the voice interface server 10 to process various information, thereby providing service in real time. Information is preferably transmitted between the voice interface server 10 and the voice interface clients 20a to 20c in the form of packets.

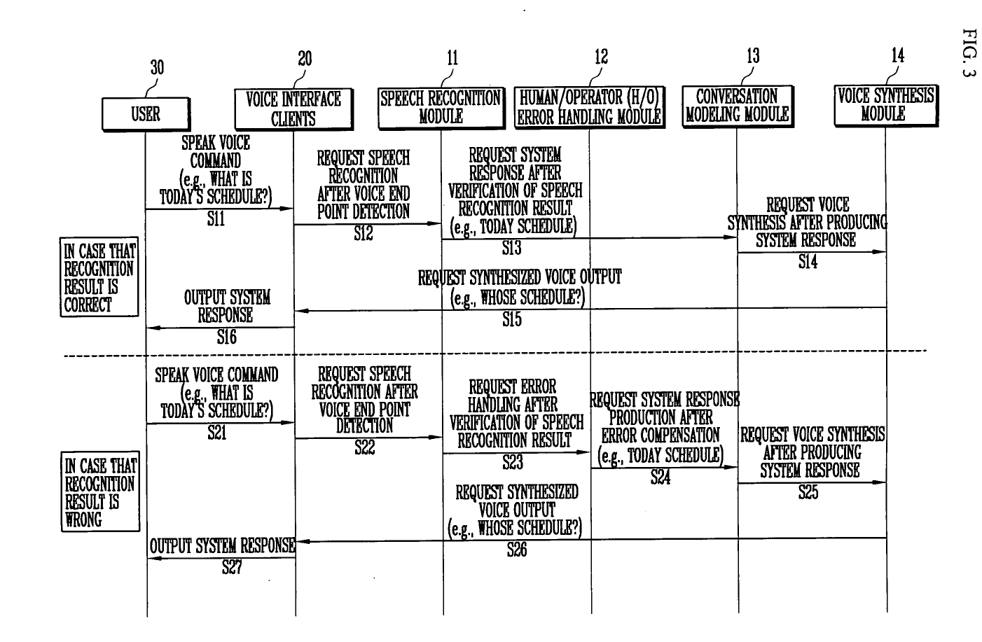

FIG. 2 is a block diagram illustrating a signal processing flow of the voice interface system of FIG. 1, and FIG. 3 illustrates an information processing procedure when speech recognition is correctly performed and when there is an error in speech recognition.

Referring to FIGS. 2 and 3, the information processing procedure when speech recognition is correctly performed includes a user 30 speaking a voice command “what is today's schedule?” (step S11), a voice interface client 20 detecting a voice section among voice data spoken by the user 30 and then transferring the voice data (step S12), the speech recognition module 11 performing speech recognition where “today” and “schedule” are correctly recognized using the voice data (step S13), the conversation modeling module 13 forming a system response “whose schedule?” according to the speech recognition result (step S14), the voice synthesis module 14 converting the system response into voice data (step S15), and the voice interface client 20 outputting the voice data to the user 30 (step S16).

The information processing procedure when there is an error in speech recognition includes the user 30 speaking a voice command “what is today's schedule?” (step S21), the voice interface client 20 detecting a voice section among voice data spoken by the user 30 and then transferring the voice data (step S22), the speech recognition module 11 performing speech recognition on the voice data and determining there to be an error (step S23), the H/O error handling module 12 correcting the error with the help of the human operator and forming a speech recognition result which is “today” and “schedule” (step S24), the conversation modeling module 13 forming a system response “whose schedule?” according to the speech recognition result (step S25), the voice synthesis module 14 converting the system response into voice data (step S26), and the voice interface client 20 outputting the voice data to the user 30 (step S27).

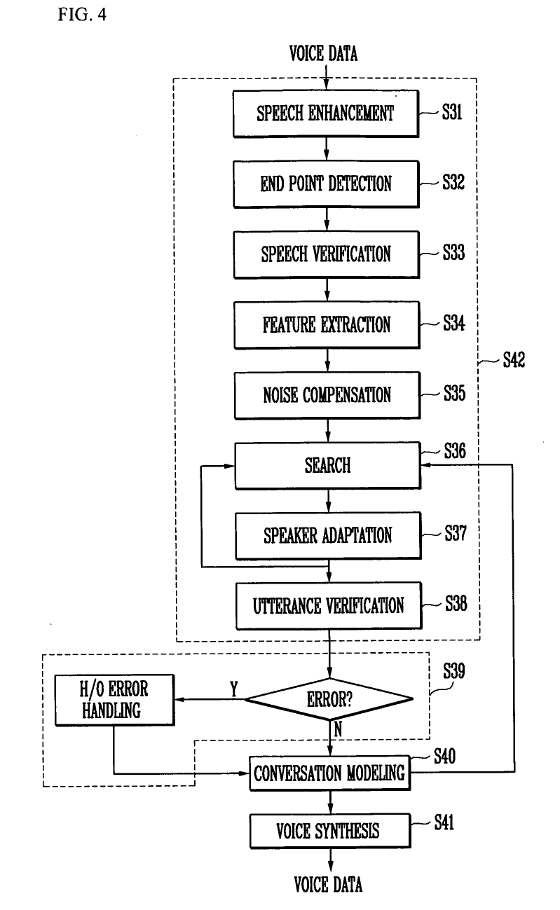

FIG. 4 is a flowchart illustrating a voice interface method which can be performed in the voice interface system of FIG. 1.

Referring to FIG. 4, the voice interface method includes a voice enhancement step (S31), a voice end point detection step (S32), a voice/non-voice verification step (S33), a voice feature extraction step (S34), a real-time noise compensation step (S35), a keyword search step (S36), an on-line speaker adaptation step (S37), a utterance verification step (S38), an H/O error handling step (S39), a conversation modeling step (S40), and a voice synthesis step (S41). Here, the voice enhancement step (S31) and the voice end point detection step (S32) can be performed in the voice interface client, and the rest steps can be performed in the voice interface server. If the voice end point detection step (S32) is divided into two steps, it can be performed such that a first step is performed in the voice interface client and a second step is performed in the voice interface server. The voice enhancement step (S31), the voice end point detection step (S32), the voice/non-voice verification step (S33), the voice feature extraction step (S34), the real-time noise compensation step (S35), the keyword search step (S36), the on-line speaker adaptation (S37), and the utterance verification step (S38) can be collectively referred to as a speech recognition step (S42). The voice/non-voice verification step (S33), the voice feature extraction step (S34), the real-time noise compensation step (S35), the keyword search step (S36), the on-line speaker adaptation (S37), and the utterance verification step (S38) can be performed in the speech recognition module. The H/O error handling step (S39) can be performed in the H/O error handling module, the conversation modeling step (S40) can be performed in the conversation modeling module, and the voice synthesis step (S41) can be performed in the voice synthesis module.

In the voice enhancement step (S31), array signal processing and Wiener filter functions are performed to remove stationary background noise and enhance a voice signal.

In the voice end point detection step (S32), a voice end point is detected to discriminate between a silence section and a voice section. Alternatively, voice end point detection can be performed in two steps: a first step of roughly detecting an end point using voice energy information, and a second step of more accurately detecting the voice end point using a global speech absent probability (GSAP) using the result of the first step as a statistic model. Here, the first step can be performed in the voice interface client and the second step can be performed in the voice interface server.

In the voice/non-voice verification step (S33), a voice section whose end point is detected is subjected to a verifying process which discriminates between voice and noise through a Gaussian mixture model (GMM)-based voice/non-voice verification method. If the voice section is determined to be noise, operation is finished, and if it is confirmed to be voice, subsequent processes are performed.

In the voice feature extraction step (S34), feature parameters of a voice (e.g., filter bank and Mel-cepstrum) are extracted.

In the noise compensation step (S35), non-stationary background noise is removed from the voice section in real time through an interactive multiple model (IMM) method. Final feature parameters from which noise is removed are used in calculating probability using an acoustic hidden Markov model (HMM), probabilities of word candidates are compared using the feature parameters, and a recognition result is output.

In the keyword search step (S36), if there are many words to be recognized (for example, more than 1,000 words), recognition time increases, and thus a high-speed search method, for example, a tree search is used in order to output a recognition result in real time. A user may speak a sentence or a single word when speaking a voice command. When the user utters a sentence, keywords are extracted and recognized, thus enabling the user to speak more naturally.

In the on-line speaker adaptation step (S37), the speaker's (user's) voice features are reflected in a personalized speaker voice model, in real time, thereby preventing degradation of recognition performance.

In the utterance verification step (S38), the speech recognition result is verified. If there is an error in speech recognition and the erroneous recognition result is output, performance is sacrificed and the user is inconvenienced. To prevent this from happening, a rejection function which outputs the system response only when it is verified that the recognition result is correct, and otherwise requests the user to speak again, is critical. The utterance verification step (S38) includes a first step of performing verification using a score value extracted from various log likelihood ratio (LLR) values (e.g., anti-model LLR score, N-best LLR score, combination of LLR score, and word duration), and a second step for enhancing reliability of utterance verification using an intermediate value output from recognition performing module steps and metadata (e.g., SNR, distinction of sex, age, number of syllables, phoneme structure, pitch, speaking speed, and dialect/accent). The voice interface server determines based on the final verified result whether to move to the next step, which is the H/O error handling step, or to the conversation modeling step, or to request the user to speak again.

The H/O error handling step 39 is performed when a speech recognition error is detected in the utterance verification step (S38) and involves the human operator correcting the error.

In the conversation modeling step (S40), the speech recognition result is received directly from the speech recognition module or the corrected speech recognition result is received from the H/O error handling step (S39), it is determined whether or not there is a meaning-related error (e.g., “today father schedule” has no meaning-related error, but “weather father schedule” has a meaning-related error) through the meaning-related error handling procedure, and a system response is output. Here the system response may be to request the user to repeat any missed words (i.e., keywords).

The voice synthesis step (S41) forms the voice data according to the system response. At this time, the voice data can be formed in an appropriate conversational style by analyzing the speaker's intentions.

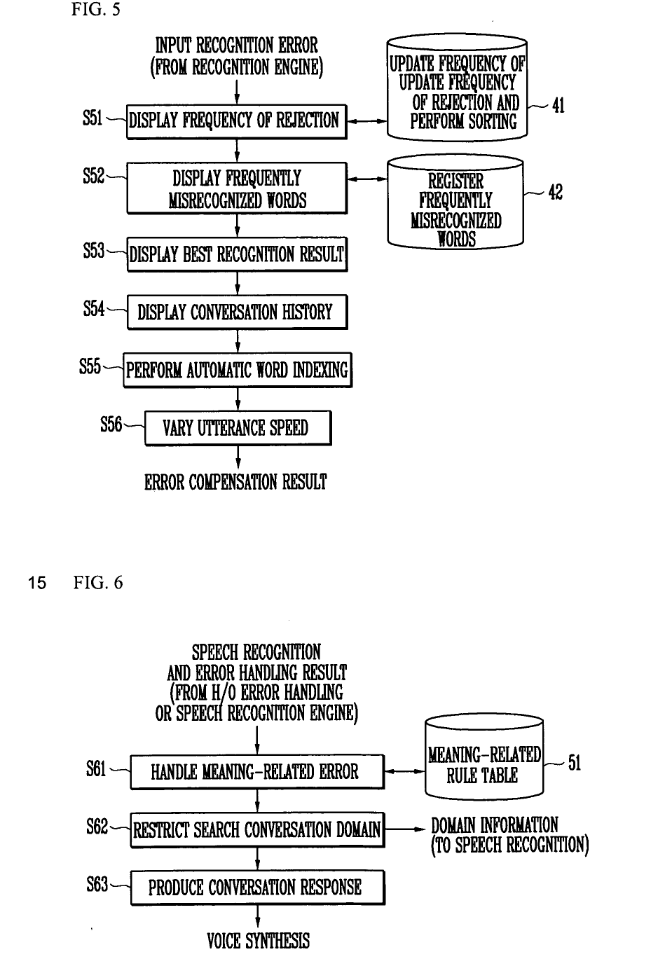

FIG. 5 is a diagram illustrating an example of the H/O error handling process in the voice interface method of FIG. 4. In the H/O error handling process, it is vital to rapidly respond to erroneous recognition results. To this end, the present invention suggests a method for efficiently correcting erroneous recognition results by a human operator.

The H/O error handling step can include a rejection frequency display step (S51). In the rejection frequency display step (S51), the frequency of rejection in the utterance verification step is updated in a database 41 and displayed in order to preferentially correct errors of users who frequently experience speech recognition errors, thereby enhancing performance and user satisfaction.

The H/O error handling step can include frequently misrecognized words display step (S52). In this step, frequently misrecognized words are registered in the database 42 and displayed, so that the operator can easily select the correct recognition result, resulting in efficient error correction.

The H/O error handling step can include a best recognition result display step (S53). In this step, words that are close to the erroneous recognition result are displayed and the correct recognition result is selected from among them.

The H/O error handling step can include a conversation history display step (S54). In this step, a log of the conversation between the user and the voice interface system is displayed so that the operator can select the correct recognition result more accurately.

The H/O error handling step can include an automatic word indexing step (S55). In this step, when phonemes are typed, words corresponding to the typed phonemes are listed so that the correct word can be obtained more rapidly with less typing.

The H/O error handling step can include an utterance speed varying step (S56). If a voice command is long, more time is required to respond with the correct recognition result in the H/O error handling step. Thus, in the utterance speed varying step (S56), a voice playback speed is increased to speed up H/O error handling.

FIG. 6 is a diagram illustrating the conversation modeling process in the voice interface method of FIG. 4.

The conversation modeling process includes a meaning-related error handling step (S61), a search conversation domain restriction step (S62), and a response conversation sentence production step (S63).

In the meaning-related error handling step (S61), it is determined whether or not there is an error in the speech recognition result, and if there is an error, a user is requested to repeat missed words (i.e., keywords). At this time, if there is ambiguity as described above, a meaning-related rule table such as Table 1 stored in a database 51 is used so that a conversion progresses according to a most similar form if a form which is not prescribed according to a rule is input.

TABLE 1

| No. | Rule | Remarks |
|---|---|---|
| Rule 1 | [name] + [schedule] | specific domain |
| Rule 2 | [date] + [weather] | weather domain |
| Rule 3 | [region] + [weather] | weather domain |
| Rule 4 | [region] + [date] + [weather] | weather domain |
| Rule 5 | [location] + [motion command] | robot motion domain |
| Rule 6 | [name] + [mail] | e-mail domain |
| Rule 7 | [name] + [telephone number] | telephone domain |
| . . . | | |

Vocabulary that the user can speak is restricted according to the conversation sentence produced in the conversation modeling step. For example, if the conversation sentence produced at the conversation modeling step is a question about “time”, the response is restricted to a date or a time. Thus, in the search conversation domain restriction step (S62), a range of keywords to be searched for in the keyword search step (S36) described above is reduced, thereby improving a speech recognition rate.

In the response conversation sentence production step (S63), the system response is produced. Table 2 lists a sequence of input and output operation states of the voice interface client (e.g., robot) and the voice interface server.

TABLE 2

| | User Action | Robot Action | Server Action |
|---|---|---|---|
| Time | | Standby state | Standby state |
| Sequence | | | On-line environment |
| | | | adaptation |
| | Robot? (user | | |
| | calls robot) | | |
| | | Remote voice input | |
| | | Speaker location | |
| | | estimation | |
| | | Voice enhancement | |
| | | Voice section | |
| | | detection | |
| | | Transmit voice | |
| | | to server | |
| | | | Perform speaker |
| | | | recognition |
| | | | Load speaker feature |
| | | | profile |
| | | Move body toward | |
| | | user and | |
| | | go to user | |
| | | | Transmit synthesized |
| | | | voice |
| | | What can I do for | |
| | | you, Mr. Kim? | |
| | | Look at user's face | |
| | | | Extract multi-model |
| | | | feature |
| | How's the | | |
| | weather today? | | |
| | (user speaks | | |
| | during system | | |
| | response) | | |
| | | Barge-in process | |
| | | | Perform keyword |
| | | | speech recognition |
| | | | On-line speaker |
| | | | adaptation |
| | | | Perform utterance |
| | | | verification |
| | | | H/O error handling |
| | | | Produce system |
| | | | response |
| | | | Transmit system |
| | | | response to robot |
| | | It is fine today | |
| | OK | | |
| | | Standby state | Standby state |

The robot (client) and the server are in the standby state at the initial stage, and a process for adapting to the environment in real time is performed by transmitting a background noise input from the robot. If a user calls “Robot” from a distant location, the robot estimates the speaker's location through an array microphone, removes the noise, detects the voice section, and transmits the voice section to the server. The server performs speaker recognition to recognize and loads the speaker's personal information to adapt to the speaker's vocal and speech characteristics. The robot turns toward the estimated location of the speaker and moves to a distance of 50 cm from the speaker. Then, the robot receives the synthesized voice from the server and outputs to the user “What can I do for you, Mr. Kim?” At this time, the robot performs face tracking via video recognition to look the user in the face and extracts multi-model information for the video information together with the voice information.

The user asks the robot a question (e.g., How is the weather today?), and the robot performs noise removal and voice end point detection and then transmits the voice to the server. The server extracts keywords (e.g., today and weather) contained in the single sentence to perform speech recognition. At this time, a barge-in processing function can be provided in order to perform speech recognition while the synthesized voice is output. The speech recognition result is obtained through on-line speaker adaptation, is verified by utterance verification, and is input directly to the conversation model process or the H/O error handling process depending on the utterance verification result. In the H/O error handling process, the erroneous speech recognition result is corrected and input to the conversation model process in which the system response to the user's query (e.g., “It is fine today in Daejeon.”) is produced and output through the conversation synthesizer. In this way, voice interfacing is performed between the user and the robot, and when a session conclusion signal (e.g., OK) is given, the robot and the server return to the standby state.

As described above, the voice interface system and method according to the present invention carry the advantage of minimizing speech recognition error by performing H/O error handling.

The voice interface system and method according to the present invention also have the advantage of being able to appropriately handle speech recognition error and user error by using the conversation modeling process to form an appropriate system response. Accordingly, an appropriate question is posed to the user when meaning-related error or speech recognition error occurs.

The voice interface system and method according to the present invention also have the advantage of improving speech recognition accuracy and speed by forming a system response using the conversation modeling process and thus reducing the range of keywords to be searched.

The voice interface system and method according to the present invention also have the advantage of an efficient H/O error handling process, in which at least one of the frequency of speech recognition error for each user, frequently misrecognized words, at least one word that is close to a misrecognized word, and the conversation history is displayed. In addition, an automatic word indexing function and/or an utterance speed varying function may be provided.

The voice interface system and method according to the present invention also have the advantage of enabling voice interface clients, e.g., robots, to be affordably priced due to the client-server structure.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A voice interface server, comprising:
a speech recognition module for performing speech recognition using voice data and detecting a speech recognition error; and
an H/O error handling module for obtaining a speech recognition result from a human operator when the speech recognition module detects a speech recognition error.

2. The voice interface server of claim 1, wherein the H/O error handling module displays at least one of a user-specific speech recognition error frequency, frequently misrecognized words, at least one word that is close to a misrecognized word, and a conversation history.

3. The voice interface server of claim 1, wherein the H/O error handling module has an automatic word indexing function.

4. The voice interface server of claim 1, wherein the H/O error handling module has an utterance speed varying function.

5. The voice interface server of claim 1, further comprising,
a conversation modeling module for producing a system response in the form of a question for correcting an error when there is a meaning-related error in the speech recognition result obtained from the speech recognition module or the H/O error handling module; and
a voice synthesis module for converting the system response into voice data.

6. The voice interface server of claim 5, wherein the speech recognition module searches through a range of words corresponding to the system response produced in the conversation modeling module.

7. A voice interface system, comprising:
a voice interface client for converting a user's voice into voice data and transmitting the voice data to a voice interface server through a communication network; and
the voice interface server for performing speech recognition using the voice data transmitted from the voice interface client and obtaining a speech recognition result from a human operator when a speech recognition error is detected.

8. The voice interface system of claim 7, wherein the voice interface server is the voice interface server according to claim 1.

9. The voice interface system of claim 7, wherein the voice interface server is the voice interface server according to claim 2.

10. The voice interface system of claim 7, wherein the voice interface client has a function for detecting an end point of the voice data converted from the user's voice.

11. The voice interface system of claim 7, wherein the voice interface client is a robot.

12. A voice interface server, comprising:
a speech recognition module for performing speech recognition using voice data;
a conversation modeling module for producing a system response in the form of a question for correcting an error when there is an error or a meaning-related error in a speech recognition result produced by the speech recognition module; and
a voice synthesis module for converting the question into voice data.

13. The voice interface server of claim 12, wherein the speech recognition module searches through a range of words corresponding to the question produced in the conversation modeling module.

14. A voice interface system, comprising:
a voice interface client for converting a user's voice into voice data and transmitting the voice data to a voice interface server through a communication network; and
the voice interface server for performing speech recognition using the voice data transmitted from the voice interface client and producing a system response in the form of a question for correcting an error when there is an error or a meaning-related error in a speech recognition result.

15. The voice interface system of claim 14, wherein the voice interface server is the voice interface server according to claim 12.

16. The voice interface system of claim 14, wherein the voice interface server is the voice interface server according to claim 13.

17. A speech recognition method, comprising the steps of:
(a) performing speech recognition using voice data and detecting a speech recognition error; and
(b) obtaining a speech recognition result from a human operator when a speech recognition error is detected in (a).

18. The speech recognition method of claim 17, wherein step (a) comprises the steps of:
(a1) extracting a feature parameter from the voice data;
(a2) searching and obtaining keywords from the extracted feature parameter; and
(a3) detecting a speech recognition error by determining whether the obtained keywords are a correct speech recognition result or an erroneous speech recognition result.

19. The speech recognition method of claim 18, wherein step (a3) comprises:
detecting a speech recognition error using a score value extracted from at least one kind of LLR value; and
detecting a speech recognition error using metadata.

20. The speech recognition method of claim 18, wherein step (a) further comprises a step (a4) of reflecting a speaker's a voice features in a speaker-specific voice feature profile in real time.

21. The speech recognition method of claim 18, wherein step (a) further comprises a step (a5) of discriminating between a silence section and a voice section of the voice data, step (a5) being performed before step (a1).

22. The speech recognition method of claim 21, wherein step (a5) comprises:
extracting a voice end point using voice energy information; and
detecting a voice end point using a GSAP.

23. The speech recognition method of claim 21, wherein step (a) further comprises a step (a6) of verifying whether the end point-detected voice data is speech or noise.

24. The speech recognition method of claim 21, wherein step (a) further comprises a step (a7) of removing stationary background noise from the voice data, step (a7) being performed before step (a5).

25. The speech recognition method of claim 18, wherein step (a) further comprises a step (a8) of removing non-stationary background noise from the feature parameters extracted in step (a1).

26. The speech recognition method of claim 17, wherein step (b) comprises a step of displaying at least one of a user-specific speech recognition error frequency, frequently misrecognized words, at least one word that is close to a misrecognized word, and a conversation history.

27. The speech recognition method of claim 17, wherein step (b) comprises a step of listing words containing typed phonemes when at least one phoneme is typed.

28. The speech recognition method of claim 17, wherein step (b) comprises a step of varying an utterance speed.

29. The speech recognition method of claim 17, further comprising the steps of:
(c) producing a question for correcting an error when there is a meaning-related error in the speech recognition result obtained in step (a) or (b); and
(d) converting the question into voice data.

30. The speech recognition method of claim 29, wherein step (c) comprises the steps of:
(c1) determining if there is a meaning-related error in the speech recognition result obtained in step (a) or (b);
(c2) producing the question; and
(c3) searching through a range of keywords corresponding to the question in subsequent speech recognition.

31. A speech recognition method, comprising the steps of:
(a) performing speech recognition using voice data;
(b) producing a system response in the form of a question for correcting an error when there is an error or a meaning-related error in a speech recognition result obtained in step (a); and
(c) converting the system response into voice data.

32. The speech recognition method of claim 31, wherein step (b) comprises the steps of:
(b1) determining if there is an error or a meaning-related error in the speech recognition result obtained in step (a);
(b2) producing the system response; and
(b3) searching through a range of keywords corresponding to the system response in subsequent speech recognition.
